(19) United States
(12) Patent Application Publication
(10) Pub. No.: US 2004/0265107 A1
(43) Pub. Date: Dec. 30, 2004

(54) Stocker and transfer system including the same

(75) Inventors: Sang-Yong Kim, Gwacheon-si (KR); Kwon-Su Park, Gwacheon-si (KR)

Correspondence Address: LEE & STERBA, P.C., Suite 2000, 1101 Wilson Boulevard, Arlington, VA, 22209, US

(73) Assignee: Samsung Electronics Co., Ltd.

(21) Appl. No.: 10/792,391

(22) Filed: Mar. 4, 2004

(30) Foreign Application Priority Data
Mar. 4, 2003 (KR) 2003-13348

(51) Int. Cl. B66F 1/00

(52) U.S. Cl. 414/626

(57) ABSTRACT

A stocker includes a power supply mounted beneath a ceiling of a process line and a cabinet. A track is also provided beneath the ceiling. A vehicle moves along the track to transport an article. The power supply transmits a rotary power in a first direction to rotate the cabinet in a second direction. The cabinet is provided with compartments for receiving the article from the vehicle. A transfer system including the stocker does not occupy floor space of the process line. Thus, the utility of the floor space of the process line can be maximized.

### BACKGROUND OF THE INVENTION

1. Field of the Invention

The present invention relates to a stocker and a transfer system including the same, and, more particularly, to a stocker for temporary storage of an article transferred along a process line, and to a transfer system having the stocker.

2. Description of the Related Art

In general, storage equipment serves to securely protect an article from external contaminants and stresses. A conventional stocker merely shelters the articles from the external environment. To efficiently store the article in the conventional stocker, additional complex parts and corresponding high-priced fittings are needed. Even though stored in the stocker, high-priced articles and equipment sensitive to surroundings may be readily deteriorated or rusted on account of carelessness.

Typical contaminants capable of affecting articles in the stocker include dust and moisture in the external environment. For decades, dust has been an inevitable problem to be dealt with in high-tech industries including semiconductor fields. In most high-tech industries, manufacturing processes are generally performed indoors. Indoor air repeatedly circulates to insure that natural dilution is efficiently performed. However, the indoor air itself may be seriously contaminated. Currently, most manufacturing interiors, such as buildings, are tightly shut to save energy. Thus, it has been important to eliminate and purify contaminants contained in the indoor air.

Recently, quality of the indoor air has become an issue due to contamination of the outdoor air by industrialization. The dirty outdoor air and dust may be passed into the interiors through ventilators. All kinds of noxious components have been increased in the indoor air, arising from the wide use of chemical adiabatic members and the tight sealing of buildings.

In the high-tech industries, particularly in the semiconductor field, air purifying technologies and air cleaning technologies are essential factors to improve competitiveness of the semiconductor yield. Furthermore, the air cleaning technologies must be completed in semiconductor memory industries dealing with increased wafer size, e.g., wafers larger than 300 mm in diameter.

Cleaning equipment for removing impurities typically occupies more than 30% of all of the space for all of the semiconductor or LCD fabricating equipment. In making finer and finer circuit widths of the semiconductor, dust and impurities have greatly influenced the semiconductor fabrication processing capability. For example, when the circuit width is not less than about 0.18 μm, dust up to about 0.09 μm in size can be tolerated. However, when the circuit width is below about 0.18 μm, dust only up to about 0.05 μm can be tolerated. Tiny contaminants are capable of deteriorating a substrate because they may peel a film of the substrate. Accordingly, the cleaning technologies are certainly essential to the current semiconductor fabrication processes. An existing dust collector converts light energy into heat energy by colliding plasma or a laser with dust particles.

In general, semiconductor device fabrication time is about 50 to about 60 days. In the semiconductor process lines making fine circuit widths, there should be almost no dust and humidity is controlled to be uniform. This requires that workers wear dust-proof clothes and enter through a clean room into the process lines. The fabricated semiconductor device is packed in a special packing material so as to be protected from the surroundings during transportation.

A system for automatically transferring a wafer includes a track disposed along the process line, a vehicle moving along the track to transfer the wafer and a stocker for temporarily storing the wafer transferred by the vehicle. The stocker receives a carrier loaded with wafers and temporarily stores the wafer-loaded carrier therein. Then, the carrier is unloaded from the stocker for successive processing.

FIG. 1 shows a conventional system for an automatic transfer of a wafer. Referring to FIG. 1, the conventional system includes a buffering apparatus 3 disposed between a front process equipment 1 and a rear process equipment 2. Robots 4 are disposed between the buffering apparatus 3 and the process equipment 1 and 2 to transfer carriers loaded with wafers there between. The buffering apparatus 3 is divided into a first buffer area 31 and a second buffer area 32 which transfer the wafer-loaded carrier, and a third buffer area 33 and a fourth buffer area 34 which transfer the empty carrier.

FIG. 2 shows a conventional tool bay including an intra bay buffer and a stocker system. Referring to FIG. 2, the tool bay provided with input/output port 14 includes a plurality of shelves 16. The shelves 16 have an upper face supporting pods. The shelves 16 are arranged in a plurality of rows and columns. A vehicle for transporting a wafer to a stocker may be a shuttle type or a hoist type.

FIG. 3 is a perspective view illustrating a conventional shuttle type vehicle. FIG. 4 is a front view illustrating a conventional stocker adapted for the shuttle type vehicle of FIG. 3. FIG. 5 is a perspective view illustrating a conventional hoist type vehicle. FIG. 6 is a front view illustrating a conventional stocker adapted for the hoist type vehicle of FIG. 5.

Referring to FIG. 3, a shuttle type vehicle 60 moves along a track 50 installed on a ceiling of a process line. The shuttle type vehicle 60 has open sides. Accordingly, as shown in FIG. 4, a stocker 40 is disposed at the open sides of the shuttle type vehicle 60 so that a wafer is loaded into or unloaded from the stocker 40 in a horizontal direction.

Referring to FIGS. 5 and 6, a hoist type vehicle 80 is suspended from a track 70. A stocker 90 is disposed below the hoist type vehicle 80 so that a wafer is loaded into or unloaded from the stocker 90 in a vertical direction.

As shown in the above figures, conventional stockers for either vehicle type are longitudinally mounted on a floor of the process line. This results in a decrease in available space for the rest of the process line.

### SUMMARY OF THE INVENTION

It is a first feature of the present invention to provide a stocker for maximizing spatial utility of a process line by minimizing floor space occupied by the stocker in the process line.

It is a second feature of the present invention to provide a transfer system including the stocker according to the invention.

At least one of the above and other features of the present invention may be realized by providing a stocker for receiving an article from a vehicle moving along a track, the stocker including a power supply mounted beneath the ceiling of the process line for transmitting a power from the power supply in a first direction, and a cabinet rotating in a second direction and connected to the power supply. The cabinet may have numerous compartments that may receive the article. The power supply may include a motor mounted beneath the ceiling and a driving shaft disposed between the motor and the cabinet. The cabinet may be suspended above a floor of the process line. The power supply may be mounted on the ceiling.

The cabinet may include an upper plate, a lower plate disposed under the upper plate and compartment plates installed between the upper plate and the lower plate for providing the cabinet with the compartments. The vehicle member may be a shuttle type vehicle moving along the track. Accordingly, the compartments are formed on a side of the cabinet.

Alternatively, the cabinet may include a lower plate, a side plate installed at sides of the lower plate and compartment plates mounted on the lower plate for providing the cabinet with the compartments. The vehicle type may be a hoist type vehicle that elevates from the track member and transfers the article to the cabinet through a bottom side of the vehicle. Accordingly, the compartments are formed on a top of the cabinet.

At least one of the above and other features may be realized by providing a transfer system including a track member mounted beneath a ceiling of a process line, a vehicle member moving along the track member for transporting an article and a stocker suspended above a floor of the process line adjacent to the track member for loading/unloading the article from/to the vehicle member. The track member may include a first and a second track disposed in parallel. The stocker may be disposed between the first track and the second track. The vehicle member may include a first vehicle moving along the first track and a second vehicle moving along the second track. The details of the stocker noted above may also be used in connection with the transfer system.

### BRIEF DESCRIPTION OF THE DRAWINGS

The above and other objects and advantages of the present invention will become readily apparent by reference to the following detailed description when considered in conjunction with the accompanying drawings wherein:

FIG. 1 is a schematic plan view illustrating a conventional system for automatically transferring a wafer;

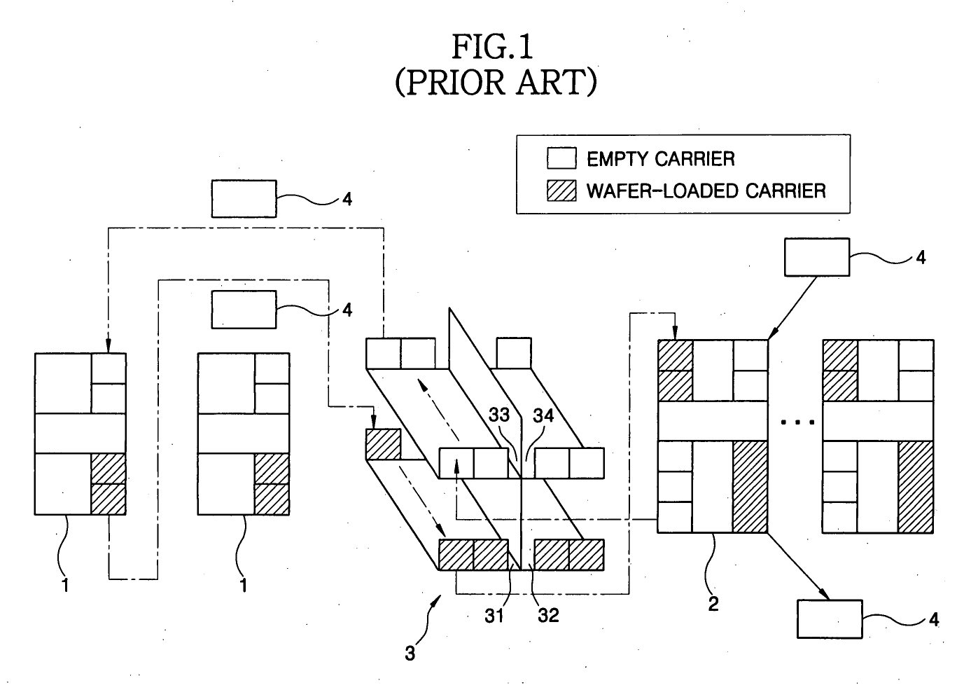

FIG. 2 is a front view illustrating a conventional tool bay including a stocker;

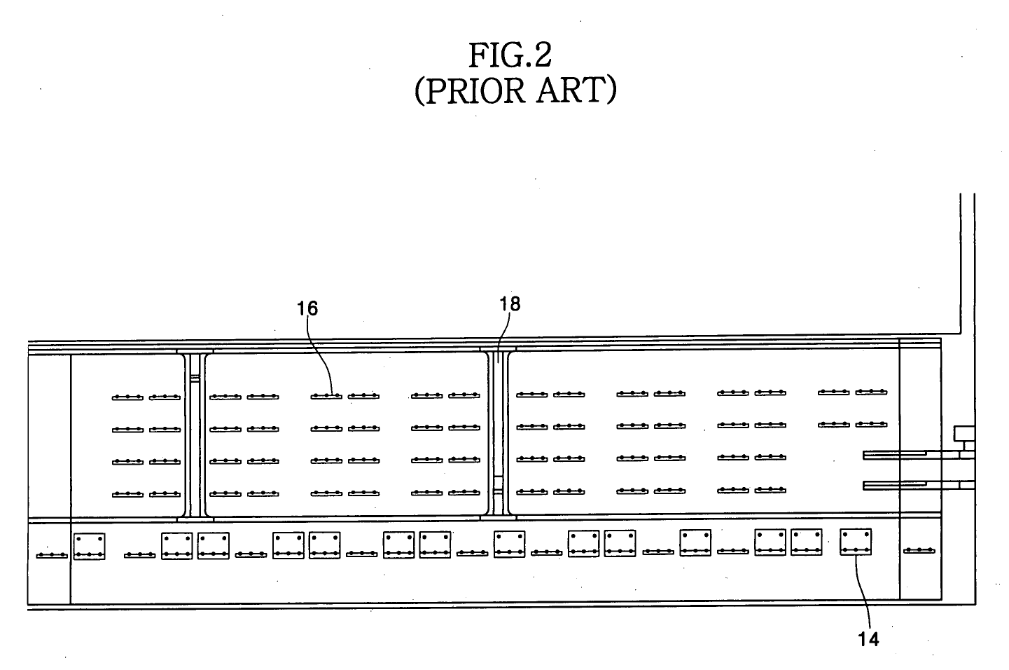

FIG. 3 is a perspective view illustrating a conventional shuttle type vehicle;

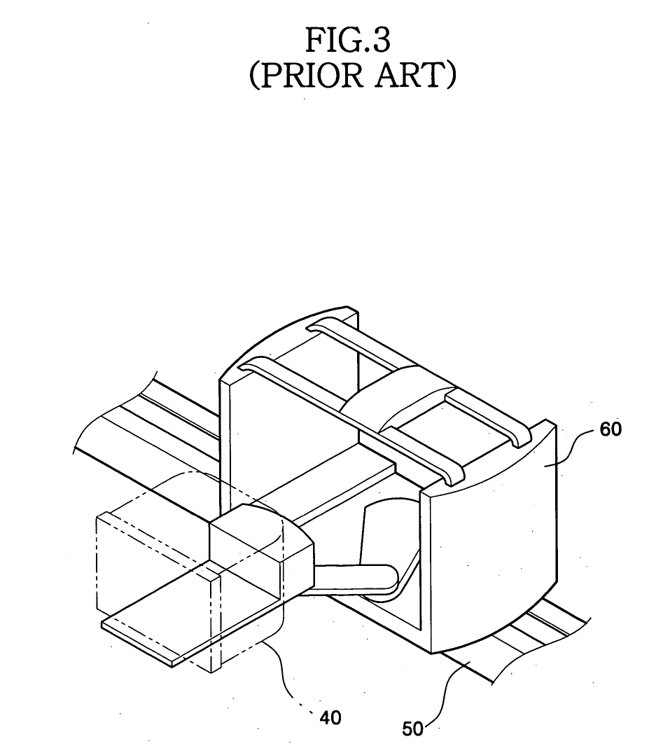

FIG. 4 is a front view illustrating a stocker adapted for the shuttle type vehicle of FIG. 3;

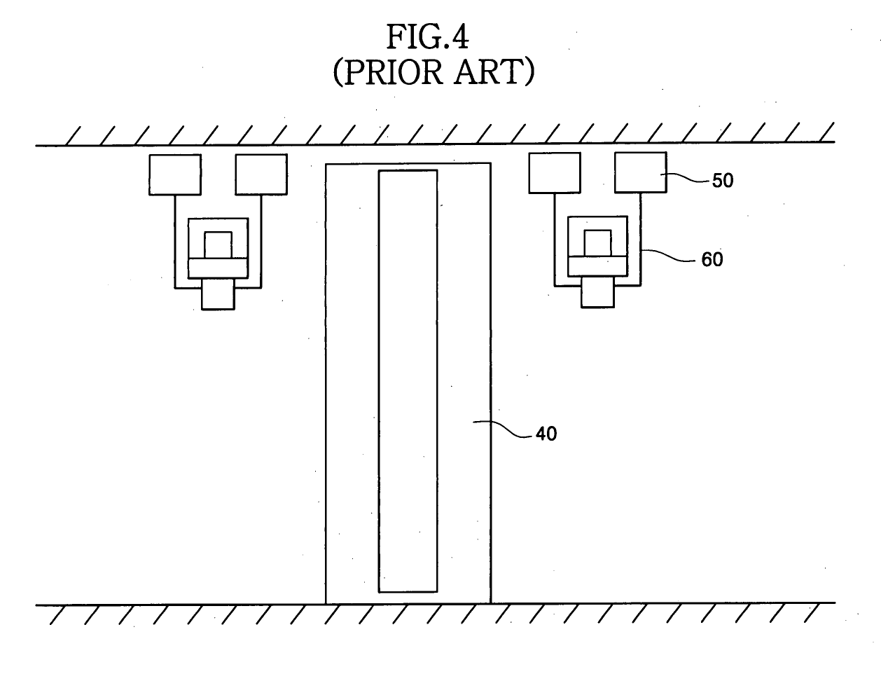

FIG. 5 is a perspective view illustrating a conventional hoist type vehicle;

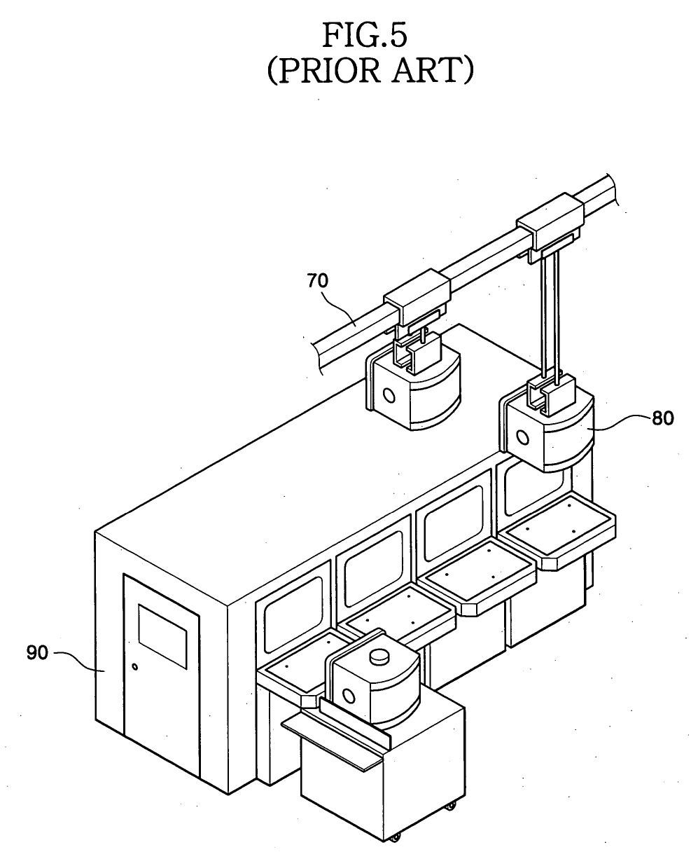

FIG. 6 is a front view illustrating the stocker adapted for the hoist type vehicle of FIG. 5;

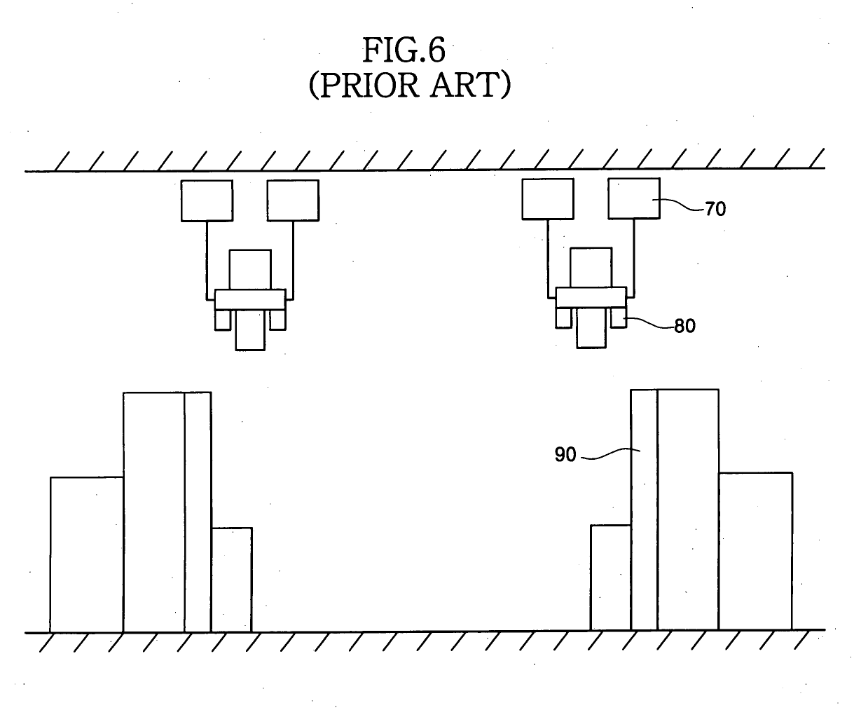

FIG. 7 is a front view illustrating a transfer system provided with a shuttle type vehicle and a stocker according to one embodiment of the invention;

FIG. 8 is a plan view illustrating the transfer system of FIG. 7;

FIG. 9 is a front view illustrating a transfer system provided with a hoist type vehicle and a stocker according to another embodiment of the invention; and

FIG. 10 is a plan view illustrating the transfer system of FIG. 9;

### DETAILED DESCRIPTION

Korean Patent Application No. 2003-13348, filed on Mar. 4, 2003, and entitled “Stocker and Transfer System Including the Same,” is incorporated by reference herein in its entirety for all purposes.

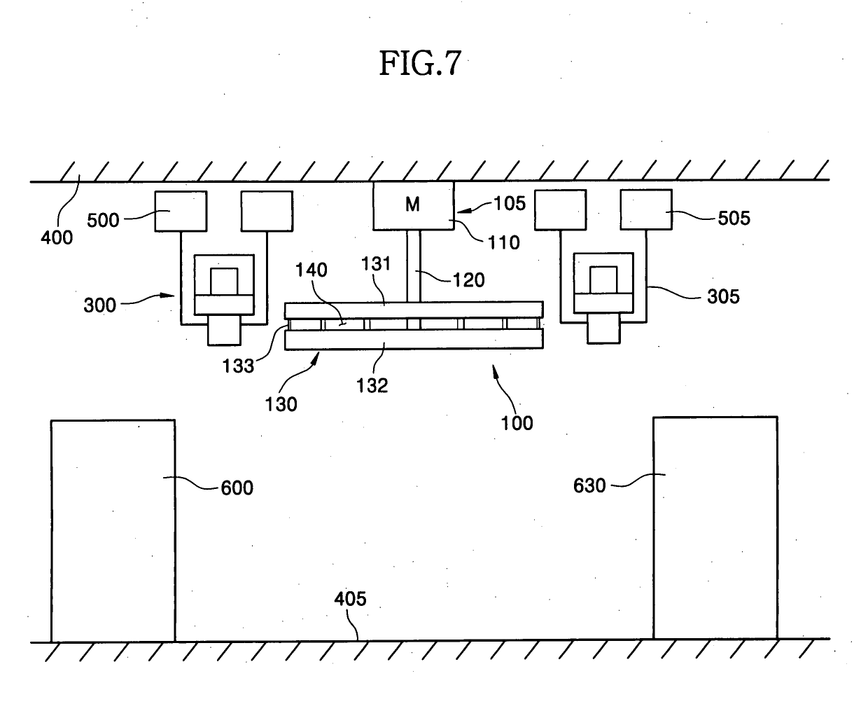

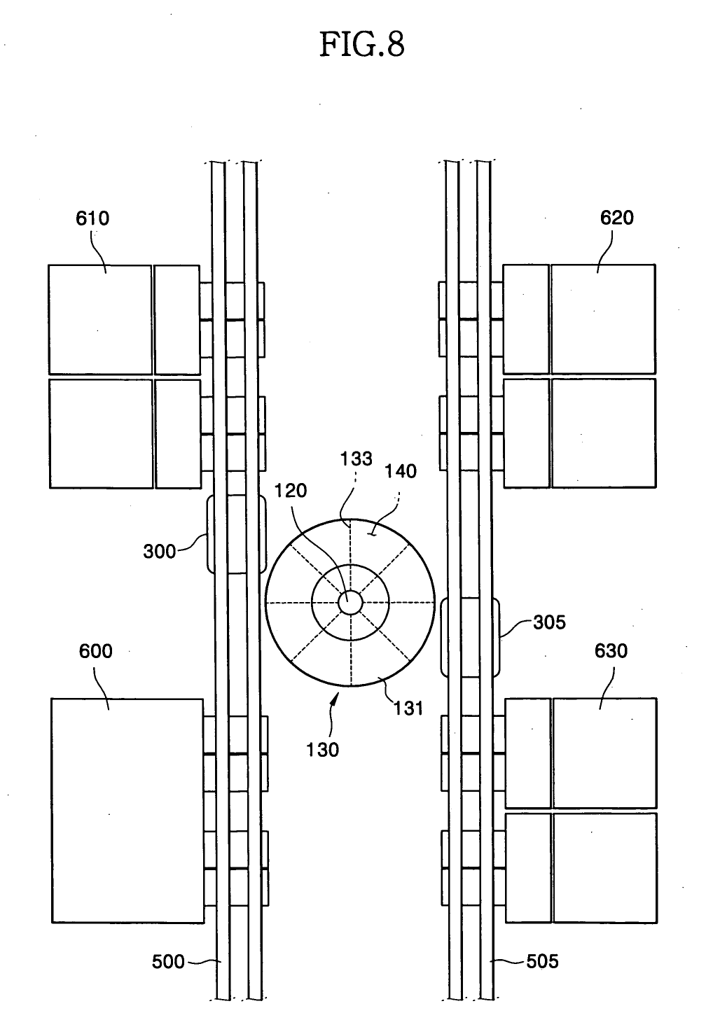

FIG. 7 is a front view illustrating a transfer system provided with a shuttle type vehicle and a stocker according to one embodiment of the invention, and FIG. 8 is a plan view illustrating the transfer system of FIG. 7.

Referring to FIGS. 7 and 8, a transfer system according to one embodiment of the invention includes a first track 500 and a second track 505 mounted beneath a ceiling 400 of a semiconductor process line, a first shuttle type vehicle 300 moving along the first track 500, a second shuttle type vehicle 305 moving along the second track 505 and a stocker 100 installed beneath the ceiling 400 between the first track 500 and the second track 505. The first track 500 is disposed at one side of the process line, and the second track 505 is disposed at the other side of the process line.

The first shuttle type vehicle 300 orients a carrier therein to a floor 405 of the process line from the first track 500. The second shuttle type vehicle 305 orients a carrier therein to the floor 405 of the process line from the second track 505. The first shuttle type vehicle 300 transports a wafer along the first track 500 on one side of the stocker 100. The second shuttle type vehicle 305 transports a wafer along the second track 505 on another side of the stocker 100. The stocker 100 receives the wafer from the first shuttle type vehicle 300 and the second shuttle type vehicle 305. The stocker 100 either temporarily stores the wafers therein or transmits the wafer to the first shuttle type vehicle 300 and the second shuttle type vehicle 305.

The first track 500 and the second track 505 are located over processing equipment 600 and 610, 620 and 630, respectively, located on the floor 405 of the process line. The processing equipment 600, 610, 620 and 630 may be any equipment needed for the processing, e.g., an etching apparatus, a depositing apparatus, a cleaning apparatus. The shuttle type vehicles 300 and 305 move along the first track 500 and the second track 505 to transport a wafer-loaded carrier over the processing equipment 600, 610, 620 and 630.

According to one embodiment, the vehicles 300 and 305 are shuttle type vehicles that transfer the wafer-loaded carrier to the stocker 100 or the processing equipment 600, 610, 620 and 630 through a side of the shuttle type vehicle 300 and 305.

Alternatively, only one of the first shuttle type vehicle 300 and the second shuttle type vehicle 305 may be adjacently disposed at the stocker 100. Accordingly, only one of the first track 500 and the second track 505 may be disposed beneath the ceiling 400 of the process line. However, numbers and arrangements of the vehicles 300 and 305 and of the tracks 500 and 505, respectively, may be varied according to dimensions, arrangement and conditions of the process line.

The stocker 100 is mounted beneath the ceiling 400 of the process line between the first track 500 and the second track 505. The stocker 100 may include a power supply 105 longitudinally mounted beneath the ceiling 400 of the process line in the direction of the bottom 405. The power supply 105 may include a motor 110 and a driving shaft 120. The motor 110 may be longitudinally mounted beneath the ceiling 400 of the process line. The driving shaft 120 transmits rotary power from the motor 110 in a first direction that is perpendicular to the ceiling 400 of the process line. The driving shaft 120 may have an upper end connected to the motor 110 and a lower end longitudinally extended towards the floor 405 of the process line. The driving shaft 120 may be rotatably connected to the motor by a bearing (not shown).

In one embodiment, the power supply 105 may have a cylinder (not shown) for lifting the motor 110 and the driving shaft 120 to control a height of the motor 110 and the driving shaft 120. When the power supply 105 has the cylinder, the height of cabinet 130 from the floor 405 of the process line can be appropriately adjusted in accordance with heights of the first shuttle type vehicle 300 and the second shuttle type vehicle 305.

The cabinet 130 may be rotatably mounted to the lower end of the driving shaft 120 in a second direction that is horizontal to the ceiling 400 of the process line. Herein, a center of the cabinet 130 is aligned with a center of the driving shaft 120 so that the cabinet 130 smoothly rotates. The cabinet 130 may be wider than it is tall. Particularly, the cabinet 130 may have a cylindrical shape. However, the cabinet 130 may be other shapes, e.g., cubic.

The cabinet 130 is provided with compartments 140 for receiving the carrier. When used with the shuttle type vehicles, the receiving compartments 140 may all have the same dimensions and may be disposed at uniform intervals in the side of the cabinet 130 along a circumference of the cabinet 130. The cabinet 130 may include a circular upper plate 131 and a circular lower plate 132. Compartment plates 133 may be installed between the upper plate 131 and the lower plate 132 in the radial direction of the cabinet 130, thereby forming the receiving compartments 140. The dimensions of the receiving compartments 140 may be varied according to the wafers to be received in the cabinet 130.

Hereinafter, the loading and unloading of the carrier to and from the stocker according to an embodiment of the present invention is described.

Referring to FIGS. 7 and 8, for example, wafers that have been processed by the processing equipment 600 and 610, e.g., cleaned, are loaded into the carrier. The carrier is loaded into the first shuttle type vehicle 300. The first shuttle type vehicle 300 moves along the first track 500 toward the cabinet 130.

Then, the carrier is loaded into a receiving compartment 140 of the cabinet 130. The receiving compartments 140 are populated with carriers by repeatedly performing the loading of the carrier. A wafer received in cabinet 130 is in stand-by for a successive process.

Subsequently, the motor 110 drives the driving shaft 120 to thereby rotate the cabinet 130. Then, the receiving compartments 140 are positioned at a front of the successive processing equipment 620 and 630.

The carriers received in the receiving compartments 140 are loaded into the second shuttle type vehicle 305. The second shuttle type vehicle 305 moves along the second track 505, thereby unloading the carrier to the successive processing equipment 620 and 630.

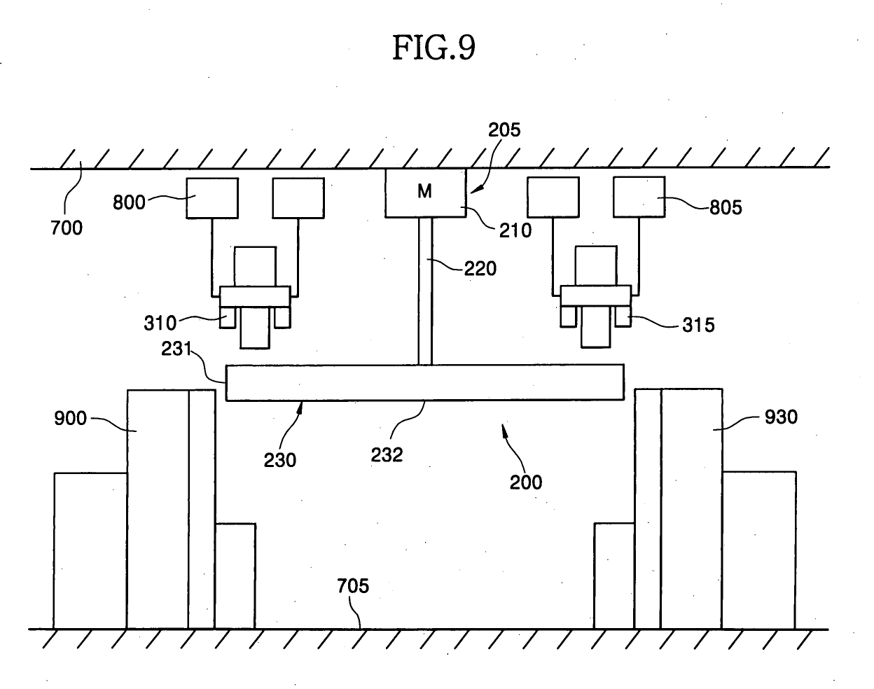

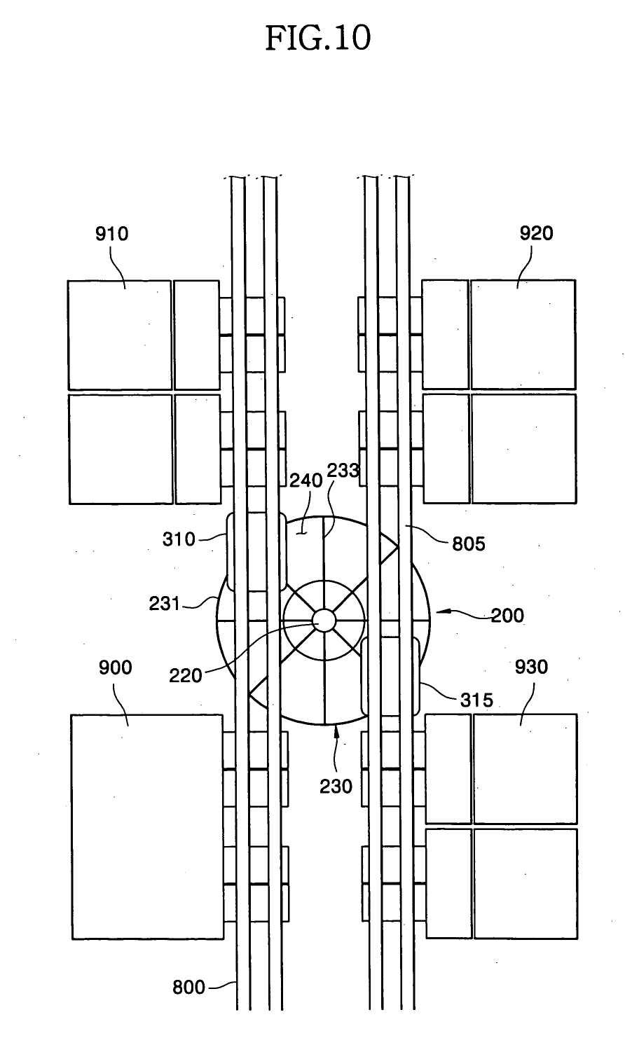

FIG. 9 is a front view illustrating a transfer system provided with a hoist type vehicle and a stocker according to another embodiment of the invention, and FIG. 10 is a plan view illustrating the transfer system of FIG. 9.

Referring to FIGS. 9 and 10, a transfer system according to another embodiment of the invention includes a first track 800 and a second track 805 mounted beneath a ceiling 700 of a semiconductor process line, a first hoist type vehicle 310 moving along the first track 800, a second hoist type vehicle 315 moving along the second track 805 and a stocker 200 installed beneath a ceiling 700 of the process line between the first track 800 and the second track 805.

The first track 800 and the second track 805 are located over processing equipment 900 and 910, 920 and 930, respectively, that are disposed on a floor 705 of the process line. The processing equipment 900, 910, 920 and-930 may be any type needed for the processing, e.g., an etching apparatus, a depositing apparatus, a cleaning apparatus. Numbers and arrangements of the vehicles 310 and 315 and of the tracks 800 and 805, respectively, may be varied according to dimensions, arrangements and conditions of the process line, as described above.

The first hoist type vehicle 310 orients a carrier to the floor 705 of the process line from the first track 800. The second hoist type vehicle 315 orients a carrier to the floor 705 of the process line from the second track 805. The first hoist type vehicle 310 moves along the first track 800 over the processing equipment 900 and 910 that are disposed on one side of the floor 705 of the process line. The second hoist type vehicle 315 moves along the second track 805 over the processing equipment 920 and 930 disposed on the other side of the floor 705 of the process line. The first hoist type vehicle 310 and the second hoist type vehicle 315 transport the wafers in the carrier to and from the processing equipments 900, 910, 920 and 930.

According to another embodiment, the vehicles 310 and 315 are hoist type vehicle that move upwards and downwards, thereby transferring the wafer-loaded carrier to the processing equipment 900, 910, 920 and 930.

The stocker 200 may include a power supply 205 longitudinally mounted beneath the ceiling 700 of the process line in the direction of the floor 705. The power supply 205 may include a motor 210 and a driving shaft 220 secured to the motor 210. The driving shaft 220 has an upper end connected to the motor 210 and a lower end longitudinally extended to the floor 705 of the process line. The driving shaft 220 transmits rotary power from the motor 210 to the cabinet 230 in a direction perpendicular to the ceiling 700 of the process line. The cabinet 230 rotates in a second direction that is horizontal to the ceiling 700. The driving shaft 220 may be rotatably supported to the ceiling 700 by a bearing (not shown).

The cabinet 230 may be rotatably mounted on the lower end of the driving shaft 220. Here, a center of the cabinet 230 is aligned with a center of the driving shaft 220 so that the cabinet 230 smoothly rotates. The cabinet 230 may be wider than tall. For example, the cabinet 230 may have a cylindrical shape. However, the cabinet 230 may be other shapes, e.g., cubic.

The cabinet 230 may be provided with compartments 240 for receiving the carrier. When used with hoist type vehicles, the receiving compartments 240 are formed on an upper side of the cabinet 230. To form the receiving compartments 240, the cabinet 230 may include a circular lower plate 232 and a ring shaped side plate 231. Compartment plates 233 may be installed from a center of the lower plate 232 in a radial direction out to the side plate 231, thereby forming the receiving compartments 240.

Hereinafter, the loading and unloading of the carrier to and from the stocker in accordance with another embodiment of the present invention is described.

Referring to FIGS. 9 and 10, wafers, which have been processed by the processing equipment 900 and 910, e.g., cleaned, are loaded into the carrier. The carrier is loaded into the first hoist type vehicle 310. The first hoist type vehicle 310 moves along the first track 800 toward the cabinet 230.

Then, the carrier is loaded into the receiving compartments 240 through the upper side of the cabinet 230. The receiving compartments 240 are occupied with the carriers by repeatedly performing the loading of the carrier. The wafer received in the cabinet 230 is in stand-by for a successive process.

Subsequently, the motor 210 drives the driving shaft 220 to thereby rotate the cabinet 230. Then, the receiving compartments 240 face the successive processing equipment 920 and 930.

Next, the carriers received in the receiving compartments 240 are loaded into the second hoist type vehicle 315. The second hoist type vehicle 315 moves along the second track 805, thereby unloading the carrier to the successive processing equipment 920 and 930.

According to the present invention, since the stocker is disposed beneath the ceiling of the process line, other processing equipment can be positioned on the floor of the process line. As a result, the floor space of the process line can be better utilized.

Having described the preferred embodiments for the stocker and the transfer system, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed is:

1. A stocker for receiving an article from a vehicle moving along a track, comprising:
a power supply mounted beneath a ceiling of a process line provided with the track, which transmits a rotary power from the power supply in a first direction; and
a cabinet rotatably connected in a second direction to the power supply and having compartments for receiving the article.

2. The stocker as claimed in claim 1, wherein the first direction is perpendicular to the ceiling, and the second direction is perpendicular to the first direction.

3. The stocker as claimed in claim 1, wherein the power supply includes a motor secured to the ceiling, and a driving shaft having an upper end fixed to the motor and a lower end connected to the cabinet.

4. The stocker as claimed in claim 1, wherein the vehicle is a shuttle type vehicle that transfers the article to the cabinet through a side of the vehicle, and the compartments are formed in a side of the cabinet.

5. The stocker as claimed in claim 4, wherein the cabinet includes an upper plate, a lower plate disposed under the upper plate and compartment plates provided between the upper plate and the lower plate to form the compartments.

6. The stocker as claimed in claim 1, wherein the vehicle is a hoist type vehicle that elevates from the track to transfer the article to the cabinet through a bottom of the vehicle, and the compartments are formed in a top of the cabinet.

7. The stocker as claimed in claim 6, wherein the cabinet includes a lower plate, a side plate provided with sides of the lower plate and compartment plates provided on the lower plate to form the compartments.

8. The stocker as claimed in claim 1, wherein the power supply is mounted on the ceiling.

9. The stocker as claimed in claim 1, wherein the cabinet is suspended above a floor of the process line.

10. A transfer system, comprising:
a track member mounted beneath a ceiling of a process line;
a vehicle member moving along the track member to transport an article; and
a stocker receiving the article, the stocker being suspended above a floor of the process line adjacent to the track member.

11. The transfer system as claimed in claim 10, wherein the track member includes a first track and a second track, and the stocker is disposed between the first track and the second track.

12. The transfer system as claimed in claim 11, wherein the vehicle member includes a first vehicle and a second vehicle, the first vehicle moves along the first track and the second vehicle moves along the second track.

13. The transfer system as claimed in claim 10, wherein the stocker includes a power supply mounted beneath the ceiling of the process line to transmit a rotary power from the power supply in a first direction, and a cabinet rotatably connected in a second direction to the power supply and having compartments for receiving the article.

14. The transfer system as claimed in claim 13, wherein the first direction is perpendicular to the ceiling, and the second direction is perpendicular to the first direction.

15. The transfer system as claimed in claim 13, wherein the power supply includes a motor mounted beneath the ceiling, and a driving shaft having an upper end fixed to the motor and a lower end connected to the cabinet.

16. The transfer system as claimed in claim 13, wherein the vehicle member is a shuttle type vehicle that transfers the article to the cabinet through a side of the vehicle, and the compartments are formed on a side of the cabinet.

17. The transfer system as claimed in claim 16, wherein the cabinet includes an upper plate, a lower plate disposed under the upper plate and compartment plates provided between the upper plate and the lower plate to form the compartments.

18. The transfer system as claimed in claim 13, wherein the vehicle member is a hoist type vehicle that elevates from the track member to transfer the article to the cabinet through a bottom of the vehicle, and the compartments are formed in a top of the cabinet.

19. The transfer system as claimed in 18, wherein the cabinet includes a lower plate, a side plate provided with sides of the lower plate and compartment plates provided on the lower plate to form the compartments.

20. The transfer system as claimed in claim 13, wherein the power supply is mounted on the ceiling.
